(19) United States
(12) Patent Application Publication
(10) Pub. No.: US 2007/0154875 A1
(43) Pub. Date: Jul. 5, 2007

(54) Apparatus, system and method for displaying information

(76) Inventor: Kathy Toelken, Troy, MI (US)

Correspondence Address: PATENTS+TMS;A Professional Corporation, 2849 W. Armitage Ave., Chicago, IL, 60647, US

(21) Appl. No.: 11/323,108

(22) Filed: Dec. 30, 2005

(51) Int. Cl. G09B 5/00

(52) U.S. Cl. 434/317

(57) ABSTRACT

An apparatus, a system and a method for displaying a visual signal and/or producing an audio signal are provided. The system and the method produce an audio signal and/or display a visual signal via a publication. The publication displays information. The publication has a display panel which displays a visual signal. The publication is a book, a magazine, a newsletter, a manual, a pamphlet and/or the like. The publication has a speaker which produces an audio signal which relates to the information. A microphone connected to the publication records the audio signal. The audio signal and the visual signal are stored in a memory connected to the publication. The publication communicates with a database remote to the publication via a network, a first server and a second server. The database stores the information, the visual signal and the audio signal.

### BACKGROUND OF THE INVENTION

The present invention generally relates to an apparatus, a system and a method for displaying information, audio signals and/or visual signals into the same. More specifically, the present invention relates to a system and a method for displaying information via a publication. The publication may display a visual signal and/or may produce an audio signal.

The publication may have a first page and/or a second page which may display information. The information may be educational, informational and/or entertaining. The information and the signals may be stored in a memory which may be incorporated within, may be connected to and/or may be in communication with the publication. The publication may have a display panel for displaying the visual signal and/or the information.

The publication may have a processing unit which may access the memory. The publication may be connected to and/or may be in communication with a network. The network may be connected to and/or may be in communication with one or more databases. The databases may store the signals and/or the information.

It is generally known to have a publication and/or a periodical, such as, a book for displaying text and/or images. The publication may be a magazine, a book, a newspaper and/or a textbook. The publication may have pages displaying the text and/or the images which may form, for example, a story, an educational lesson and/or an informational article. The images and/or the text may be printed, inked and/or sketched onto the pages of the publication.

It is also generally known to have a switch incorporated within the periodical. The switch may activate a sound. The switch may be depressed to produce the sound. A user may view a first page and activate a first switch which may correspond to the text and/or the image displayed on the first page. The user may turn the first page to display a second page. The second page may display text and/or images different from the first page. The periodical is limited to producing the sounds stored in the periodical. In addition, the periodical merely displays static images.

Furthermore, it is known to have a series of periodicals or textbooks. The periodical and/or the textbook may have a first edition, a second edition and a third edition. Generally, each subsequent edition improves on the previous edition or adds information to the previous edition. A user is required to purchase each subsequent edition. As a result, the user is required to continually purchase a new edition. Accordingly, money spent on the previous edition of the periodical or textbook is wasted and the previous edition becomes useless.

Moreover, it is generally known that periodicals will have a number of errors, such as, for example, typos, missing information and/or incorrect information. A first error may be located by a first user. A second error may be located by a second user which is remote to the first user. As a result, the first user may not locate the second error. Similarly, the second user may not locate the first error.

A need, therefore, exists for an a system and a method for displaying information with a publication. Additionally, a need exists for a publication and a system for displaying a visual signal and/or producing an audio signal. Further, a need exists for a publication and a system having a memory for storing a visual signal, an audio signal and/or information. Still further, a need exists for a system and a method for incorporating signals into a publication which may communicate with a processor. Moreover, a need exists for a publication having a processor in communication with a network. Moreover, a need exists for a system and a method for incorporating signals into a publication which may display the signals a three-dimensional image. Furthermore, a need exists for a system and a publication which may be in communication with a database which may store information. In addition, a need exists for a system and a method for displaying a visual signal and/or producing an audio signal with a publication which may communicate with a network and/or a server. Further, a need exists for a publication and a system for producing an audio signal which may be digitized sound. Still further, a need exists for a publication incorporating an audio signal and/or a visual signal which may be stored in memory, such as, holographic memory. Moreover, a need exists for a publication which produces an audio signal and a dynamic visual signal.

### SUMMARY OF THE INVENTION

The present invention generally relates to an apparatus, a system and a method for displaying information. More specifically, the system and the method may produce an audio signal and/or display a visual signal with a publication. The publication may display information which may be educational, informational, entertaining and/or the like. The visual signal and/or the audio signal may be stored on a memory. The publication may have a microprocessor which may access the memory. The microprocessor may be connected to a network which may access a database.

The database may store the visual signal and/or the audio signal. The audio signal and/or the visual signal may correspond to, may relate to and/or may be associated with the information of the publication. The publication may have a user interface which may interact with a user of the publication. The user interface may communicate with the microprocessor. The visual signal may be displayed at a distance from the publication. The visual signal may be, for example, a holographic image which may be displayed as a three-dimensional image. The user interface may communicate with the microprocessor to access the visual signal and/or the audio signal which may be stored on the memory.

To this end, in an embodiment of the present invention, an apparatus for displaying information is provided. The apparatus has a first page that displays the information. Further, the apparatus has a display panel in communication with the first page wherein the display panel displays an image wherein the image is dynamic wherein the image changes with time and further wherein the image is described or representative of the information. Still further, the apparatus has a memory in communication with the first page wherein the memory stores the image. Moreover, the apparatus has an input means in communication with the memory wherein the input means accesses the image from the memory.

In an embodiment, the apparatus has a speaker in communication with the memory wherein the speaker produces a sound wherein the sound is associated with the information.

In an embodiment, the memory is holographic memory.

In an embodiment, the apparatus has a microphone in communication with the memory wherein the microphone records a sound.

In an embodiment, the image is a holographic image.

In an embodiment, the apparatus has a microprocessor in communication with the memory wherein the microprocessor accesses the image from the memory.

In another embodiment of the present invention, a system for displaying a visual signal and producing an audio signal is provided. The system has a publication having a first page which displays information. Further, the system has a display panel in communication with the publication wherein the display panel displays the visual signal wherein the visual signal is animated wherein the visual signal corresponds to the information. Still further, the system has a memory in communication with the publication wherein the memory stores a signal corresponding to the image.

In an embodiment, the system has an input means in communication with the memory wherein the inputs means activates the visual signal.

In an embodiment, the system has a speaker in communication with the memory wherein the speaker produces the audio signal wherein the audio signal relates to the information.

In an embodiment, the image is a holographic image.

In an embodiment, the system has a microphone in communication with the memory wherein the microphone converts the audio signal into data.

In an embodiment, the system has a microprocessor in communication with the memory wherein the microprocessor access the image from the memory.

In another embodiment of the present invention, a method for producing an audio signal or displaying a visual signal with a publication is provided. The method has the step of displaying information on the publication. Further, the method has the step of providing a display panel in communication with the publication wherein the display panel displays the visual signal wherein the visual signal is associated with the information. Still further, the method has the step of providing an input means in communication with the publication wherein the input means inputs the information. Moreover, the method has the step of accessing a database remote to the publication wherein the database stores the information or the visual signal.

In an embodiment, the method has the step of providing a speaker in communication with the publication wherein the speaker produces the audio signal wherein the audio signal is associated with the information.

In an embodiment, the method has the step of providing a microphone in communication with the publication wherein the microphone records the audio signal.

In an embodiment, the image is a holographic image.

In an embodiment, the method has the step of providing a microprocessor in communication with the publication wherein the microprocessor accesses the memory to display the image.

In an embodiment, the method has the step of providing a memory in communication with the publication wherein the memory stores the visual signal.

In an embodiment, the method has the step of transmitting the information from the database to the memory.

In an embodiment, the method has the step of transmitting the visual signal from the database to the memory.

It is, therefore, an advantage of the present invention to provide an apparatus, a system and a method for producing an audio signal and/or displaying a visual signal.

Another advantage of the present invention is to provide a periodical having a microprocessor which may access a memory.

And, another advantage of the present invention is to provide a system and a method for producing an audio signal and/or displaying a visual signal with a publication which may be stored in the publication.

Yet another advantage of the present invention is to provide a publication which may have a microprocessor in communication with a network.

A further advantage of the present invention is to provide a system and a method for providing a publication having a user interface for accessing a microprocessor and/or a memory.

Moreover, an advantage of the present invention is to provide a system and a method for accessing and/or transferring a visual signal and/or an audio signal from a database via a network.

And, another advantage of the present invention is to provide a system and a method for displaying information which may be edited via a microprocessor and/or a user interface.

Yet another advantage of the present invention is to provide a system and a method for producing an audio signal which may be digitized sound, such as, for example, a human voice.

Another advantage of the present invention is to provide a system and a method for displaying a visual signal which may be a three-dimensional image.

And, another advantage of the present invention is to provide a publication having a memory for storing a visual signal and/or an audio signal.

Yet another advantage of the present invention is to provide a publication for accessing a remote database which may store information, an audio signal and/or a visual signal.

A further advantage of the present invention is to provide a publication for communicating to a second user which may be remote to a first user interacting with the publication.

Additional features and advantages of the present invention are described in, and will be apparent from, the detailed description of the presently preferred embodiments and from the drawings.

### BRIEF DESCRIPTION OF THE DRAWINGS

FIG. 1 illustrates a top plan view of an apparatus and a system for displaying information in an embodiment of the present invention.

FIG. 2 illustrates a side plan view of an apparatus and a system for displaying information in an embodiment of the present invention.

FIG. 3 illustrates a black box diagram of a system having a publication in an embodiment of the present invention.

FIG. 4 illustrates a flowchart of a method for displaying the information in an embodiment of the present invention.

### DETAILED DESCRIPTION OF THE PREFERRED EMBODIMENTS

The present invention relates to an apparatus, a system and a method for displaying information. More specifically, the present invention relates to a system and a method for displaying information, an audio signal and/or a visual signal with a publication. The information may be stored and/or may be displayed on the publication. The information may be educational, informational, entertaining and/or the like. The publication may store the information, the visual signal and/or the audio signal in a memory. A microprocessor may access the memory to activate the audio signal and/or to display the visual signal and/or the information. The microprocessor may be in communication with a server which may be in communication with a remote database. The remote database may store the information, the audio signal and/or the visual signal.

A user interface may control the microprocessor. The user interface may change and/or may activate the visual signal, the audio signal and/or the information of the publication. The publication may project the visual signal. The audio signal and/or the visual signal may correspond to and/or may relate to the information of the publication. The audio signal and/or the visual signal may be created, may be edited, may be transmitted and/or may be received by the publication.

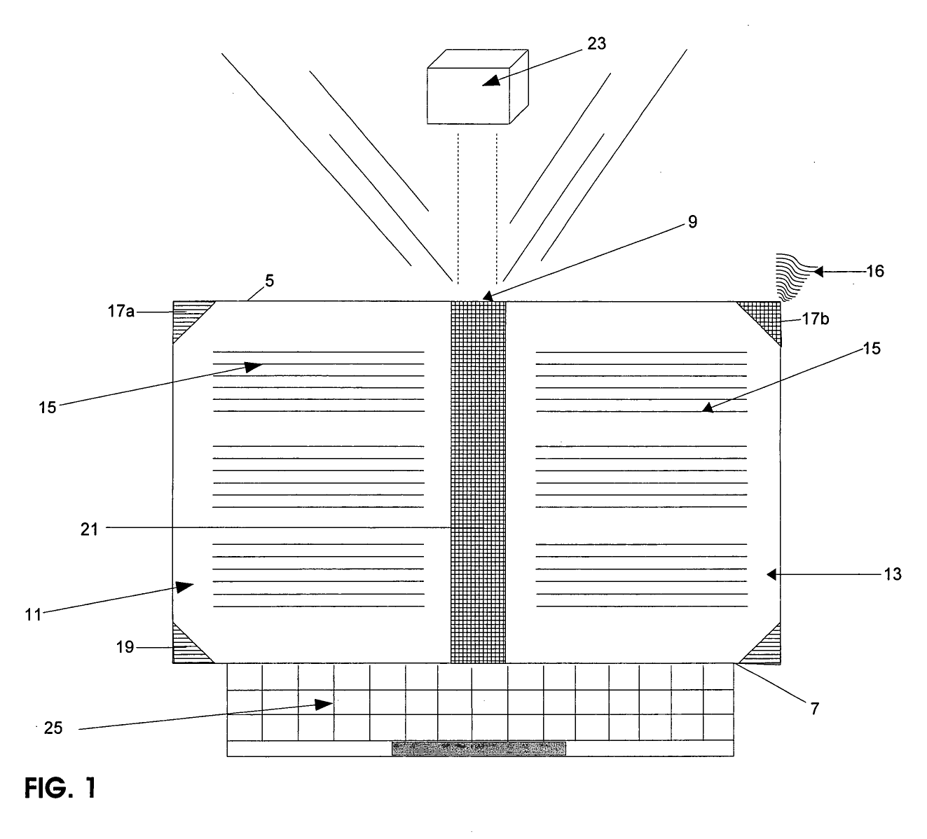

Referring now to the drawings wherein like numerals refer to like parts, FIG. 1 illustrates a top plan view of a publication 3 in an embodiment of the present invention. The publication 3 may be a textbook, a diary, a manual, a book, a letter, a pamphlet, a brochure, an advertisement, a sign and/or the like. The publication 3 may be a periodical, such as, for example, a magazine, a newspaper, a newsletter and/or the like. The publication 3 may be part of a series of books, magazines, textbooks and/or the like. The publication 3 may have a top cover 5 and a bottom cover 7. The top cover 5 and the bottom cover 7 may be connected and/or may be attached via a binding 9.

The first page 11 and/or the second page 13 may display information 15. The information 15 may be printed, inked, sketched, painted, illuminated and/or like on the first page 11 and/or the second page 13. The first page 11 and/or the second page 13 may be a display, such as, for example, a television screen, a computer monitor, a touch screen and/or the like. The first page 11 and/or the second page 13 may be a liquid crystal display, a plasma display, a touch screen display and/or the like.

Speakers 17a,17b may be connected to and/or may be attached to the publication 3. The speakers 17a,17b may produce an audio signal 16, for example, a sound, such as, for example, a song, a voice, a spoken story, a speech, a hymn, a musical tone and/or the like. The audio signal 16 may be digitized true sound.

A microphone 19 may be connected to and/or may be attached to the publication 3. The microphone 19 may be external to the publication 3. The microphone 19 may record and/or may convert the audio signal 16 from, for example, a sound into data which may be stored and/or may be displayed by the publication 3. The speakers 17a, 17b may play the audio signal 16 which was recorded by the microphone 19.

The publication 3 may have a display panel 21 which may display a visual signal 23, such as, for example, images, graphics, figures, art, people, cartoon characters, sculptures and/or the like. The visual signal 23 may be dynamic, such as, for example, a movie, a television show, a cartoon, a video game and/or the like. The visual signal 23 may be an animated object which may relate to and/or may correspond to the information 15. The visual signal 23 may be, for example, a holographic user interface which may be in communication with the publication 3 via, for example, infrared sensors (not shown). The holographic user interface allows a finger and/or a hand (not shown) to move, to rotate and/or to manipulate the visual signal 23 by touching and/or by contacting the visual signal 23. The visual signal 23 may be, for example, a holographic keyboard which may be contacted to input the information 15.

The display panel 21 may be a display screen, such as, for example, a computer monitor, a television screen and/or the like. The display panel 21 may project the visual signal 23 from the publication 3. The display panel 21 may display the visual signal 23 as a three-dimensional image. The display panel 21 may be a holographic display screen, such as, for example, a digital micro-mirror device, a dynamic holographic projection, an autostereoscopic video digital display, a holographic panel, a heliodisplay and/or the like. The display panel 21 may be in communication with the visual signal 23. The present invention should not be deemed limited to a specific embodiment of the display panel 21. The display panel 21 may be any device for displaying the visual signal 23 as known to one having ordinary skill in the art.

The publication 3 may have an input device 25, such as, for example, a keyboard, a button, a switch, a touch panel display, a knob and/or the like. The input deice 25 may be connected to and/or may be attached to the publication 3. The input device 25 may be connected to and/or may be in communication with the publication 3. The input device 25 may be located on and/or me be positioned on the first page 11 and/or the second page 13. Touching, turning and/or contacting the first page 11 and/or the second page 13, for example, may input and/or may edit the information 15. The present invention should not be deemed limited to a specific embodiment of the input device 25. The input device 25 may be any input device as known to one having ordinary skill in the art.

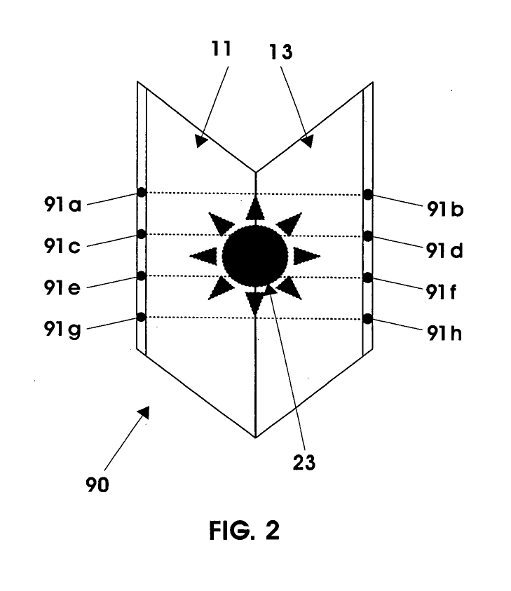

FIG. 2 illustrates a side plan view of a publication 90 in an embodiment of the present invention. The first page 11 and/or the second page 13 may display the information 15. The information 15 may be printed, inked, sketched, painted, illuminated and/or like on the first page 11 and/or the second page 13. The publication 90 may have light sources 91a-91h which may display the visual signal 23. The light sources 91a-91h may be, for example, lasers, such as, for example, infrared lasers. The light sources 91a-91h may transmit light from the first page 11 and/or the second page 13. The light may be diffracted to produce the visual signal 23 which may be a holographic image. The light source 91a may contact, for example, the light source 91b to produce the visual signal 23. In an embodiment, the light source 91a may be a reference beam; and the light source 91b may be a signal beam. By displaying the visual signal 23 and producing the audio signal 16, the apparatus 90 may replicate, for example, a theater.

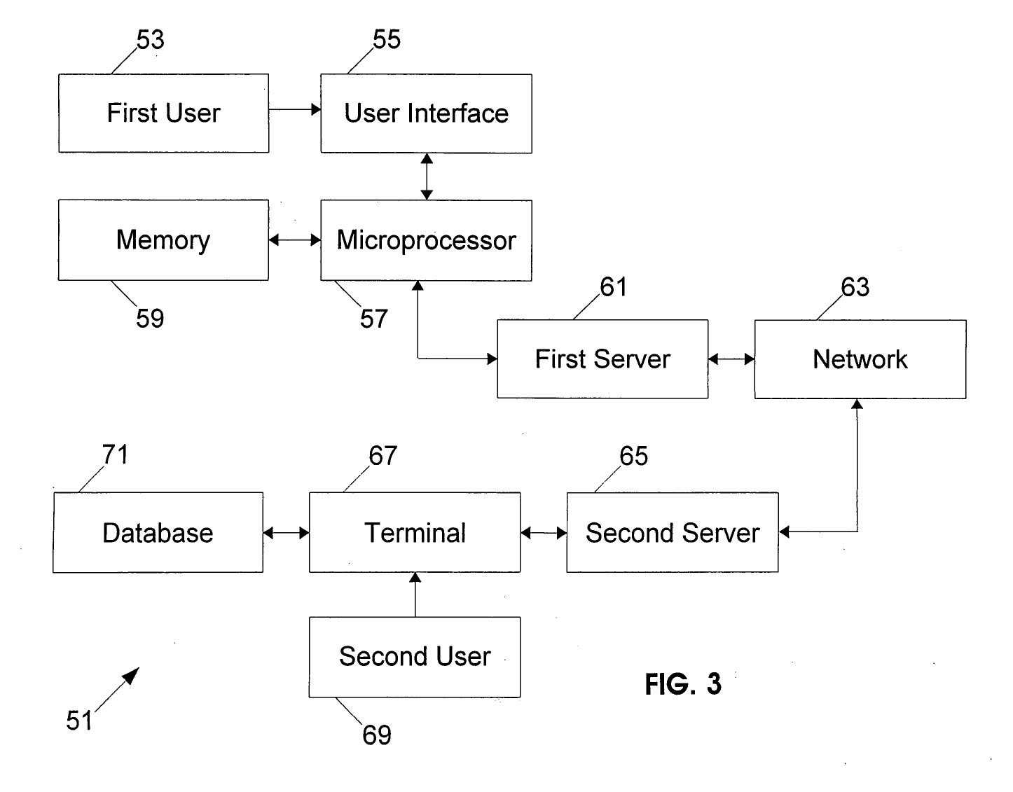

FIG. 3 illustrates a black box diagram of a system 51 in an embodiment of the present invention. A first user 53 may access and/or may communicate with a user interface 55 which may be incorporated into the first page 11 and/or the second page 13 of the publication 3. The user interface 55 may be the first page 11, the second page 13, the input device 25 and/or the display panel 21. The user interface 55 may display the information 15, the audio signal 16 and/or the visual signal 23. The user interface 55 may display choices, options and/or selections relating to the information 15. For example, the user interface 55 may have an option to edit the information 15, to transmit the information 15 and/or to display the information 15. The user interface 55 may be in communication with and/or may be connected to a microprocessor 57. The microprocessor 57 may access the information 15 from a memory 59.

The memory 59 may be connected to and/or may be in communication with the microprocessor 57. The memory 59 may be removable, such as, for example, a flash drive, a floppy disc, a compact disc, a digital versatile disc (“DVD”) and/or the like. The memory 59 may be incorporated within the publication 3, such as, for example, a hard drive. The memory 59 may store the information 15, the visual signal 23 and/or the audio signal 16. The memory 59 may be a three-dimensional storage device, such as, for example, a holographic memory. The memory 59 may store the visual signal 23, the information 15 and/or the audio signal 16 optically. The memory 59 may be connected to, may be attached to and/or may be incorporated within the publication 3. The present invention should not be deemed limited to a specific embodiment of the memory 59. The memory 59 may be any data storage device as known to one having ordinary skill in the art.

The memory 59 may be controlled by and/or may be accessed by the microprocessor 57. The microprocessor 57 may locate and/or may access the memory 59 to display the information 15. The microprocessor 57 may transmit the information 15 and/or may receive the information 15 from a first server 61. A network, such as, for example, the Internet, may connect and/or may provide communication between the first server 61 and a second server 65. The first server 61 and/or the second server 65 may be remote from the publication 3.

A terminal 67 may be connected to and/or may be in communication with the second server 65. The terminal 67 may be a computer, a personal digital assistant, a cellular phone and/or the like. The terminal 67 may be in communication with and/or may be connected to a database 71. The terminal 67 may access, may transmit and/or may receive the information 15 from the database 71.

The information 15 may be educational, informative, entertaining, motivational and/or the like. The information 15 may be text, pictures, graphics, diagrams and/or the like. In an embodiment, the information 15 may be text with corresponding Braille text. The speakers 17a,17b may produce the audio signal 16 which may be, for example, a spoken voice of the printed text corresponding to the Braille text. The first user 53 may communicate via the Braille text with the second user 69 as illustrated in FIG. 3.

In an embodiment, the information 15 may relate to music, such as, for example, types of musical instruments, producing a sound with a musical instrument, playing a musical instrument, constructing a musical instrument, a history of music, a musical artist and/or the like. For example, the information 15 may relate to orchestral instruments, and the speakers 17a,17b may produce the audio signal 16 which may be, for example, a sound produced by an orchestral instrument. The visual signal 23 may be, for example, an orchestral instrument. The first user 53 may control the audio signal 16 and/or the visual signal 23 via the input device 25. The input device 25 may control, for example, a volume level and/or a tone of the audio signal 16. The first user 53 may contact and/or may touch the orchestral instrument to sound the audio signal 16.

The publication 3 may interact with the first user 53 to provide, for example, lessons on playing a musical instrument. The microphone 19 may record the audio signal 16 which may be produced from the first user 53 via a musical instrument (not shown). The audio signal 16 may be compared to the audio signal 16 stored in the memory 59. The visual signal 23 may display, for example, techniques for playing the musical instrument, hand positions and/or mouth positions for the musical instrument and/or the like. The first page 11 and/or the second page 13 may display, for example, a touch tone keypad, such as, for example, piano keys and/or the like. The publication 3 may communicate with the database 71 via the network 63 to access and/or to receive the information 15.

In another embodiment, the information 15 may relate to technology, for example, the history of computers, types of computing, types of communication devices, instruction on using a communication device, types of programming languages, instruction on using programming languages, human interface strategies, decision models and/or the like. The publication 3 may be a series of books, such as, for example, an introduction to a programming language, an intermediate level book for a programming language and/or an expert level book for a programming language.

Further, in an embodiment, the information 15 may relate to a foreign language, such as, for example, instruction on speaking, writing and/or reading the foreign language, speaking and/or understanding foreign dialects, singing and/or information on foreign songs and/or the like. In such an embodiment, the audio signal 16 may be, for example, a native speaker of the foreign language. The microphone 19 may record the first user 53 repeating the audio signal 16. The speakers 17a, 17b may play the audio signal 16 of the native speaker and/or the audio signal 16 of the first user 63.

Still further, in an embodiment, the information 15 may relate to history, such as for example, a history textbook, a historical figure, a war, a time period and/or the like. In such an embodiment, the display panel 21 may display the visual signal 23 which may be, for example, a person of historical significance, an image relating to the information 15, a map relating to the information 15 and/or the like.

Moreover, the information 15 may relate to an invention, such as, for example, a biography of an inventor, constructing the invention, operating the invention, future innovations related to the invention and/or the like. In such an embodiment, the display panel 21 may display the visual signal 23 which may be, the invention, the inventor and/or the like. The first user 53 may access the database 71 via the network 63 to, for example, gather further information about the invention, purchase the invention and/or the like. The first user 53 may edit and/or may alter the invention via the input device 25.

Furthermore, in an embodiment, the information 15 may relate to people, such as, for example, a personal story, a collection of stories of children around the world, information relating to the lifestyle of people in a country or a region within a country, information relating to where a person resides and/or lives and/or the like. The first user 53 may be, for example, a child in China, which may communicate with the second user 69 which may be, for example, a child in Australia. The first user 53 and the second user 69 may, for example, transfer the information 15 which may be, for example, stories, experiences and/or the like. The first user 53 and/or the second user 69 may create and/or may edit the information 15. The first user 53 and the second user 69 may communicate via the network 63, the first server 61 and/or the second server 65 by, for example, instant messaging, emailing, text messaging and/or the like.

In addition, the information 15 may relate to strategies, such as, for example, problem solving strategies, test taking strategies, communication strategies and/or the like. The information 15 may be, for example, problems, questions and/or the like which may correspond to strategies described by the information 15. The input device 25 may input the information 15 which may relate to, for example, an answer to a question which may have been answered using a strategy described by the information 15.

Further, the information 15 may relate to an educational subject, such as, for example, spelling, English, mathematics, science and/or the like. The visual signal 23 may be, for example, a character for answering mathematic questions and/or explaining how to approach a mathematic problem. The present invention should not be deemed limited to a specific embodiment of the information 15. The information 15 may be any information as known to one having ordinary skill in the art.

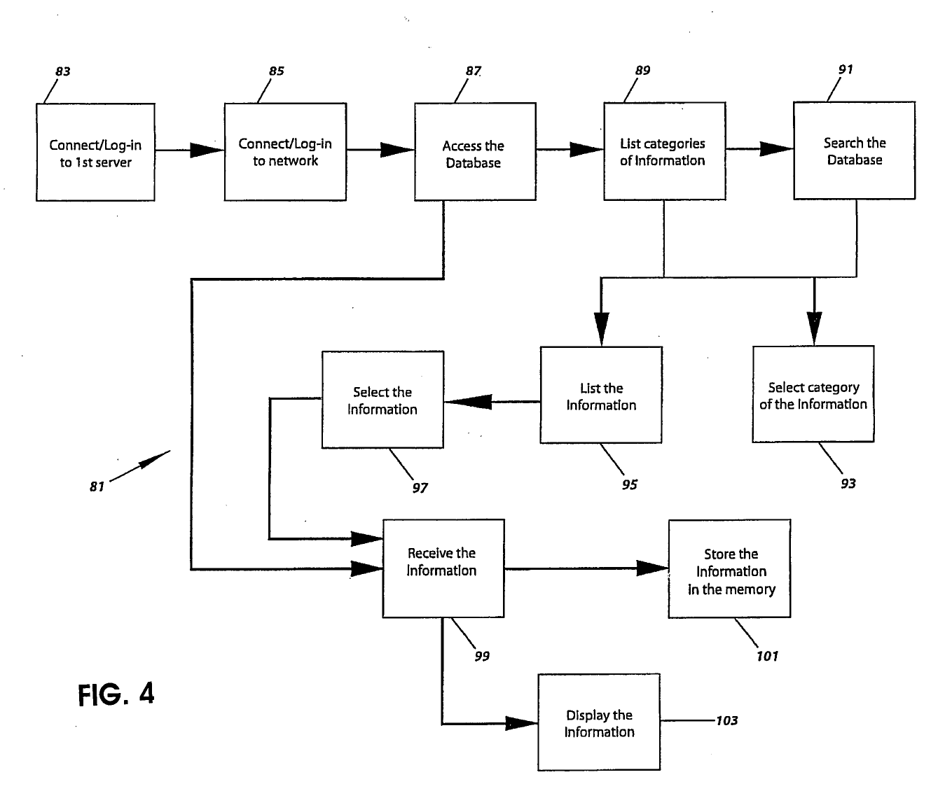

FIG. 4 illustrates a flowchart of a method 81 for displaying the information 15 in an embodiment of the present invention. The publication 3 may connect and/or log into the first server 61 as shown at step 83. The publication 3 may connect and/or log into the network 63 as shown at step 85. The publication 3 may access to the database 71 as shown at step 87. The database 71 may store the information 15, the visual signal 23 and/or the audio signal 16. The database 71 may list categories of the information 15 as shown at step 89.

The first user 53 may select the category of information as shown at step 93. Alternatively, the first user 53 may search the database 71 for the information 15 as shown at step 91. The database 71 may list the information 15 in the selected category and/or list the information 15 resulting from the search as shown at step 95. The first user 53 may select the information 15 as shown at step 97. The publication 3 may receive the information 15 as shown at step 99. The publication 3 may store the information 15 as shown at step 101 and/or may display the information as shown at step 103.

Alternatively, the publication 3 may automatically connect to the first server 61, the network 63 and/or the database 71 to update the information 15 of the publication 3. In such a case, the publication 3 may receive the information 15 as shown at step 99.

The publication 3 may have the first page 11 and the second page 13 which may display the information 15. The publication 3 may be a book, a magazine, a newspaper, a textbook and/or the like. The information 15 may be educational, informational and/or entertainment information. The publication 3 may have the display panel 21, the speakers 17a, 17b and the microphone 19. The display panel 21 may display and/or may project the visual signal 23. The speakers 17a, 17b may produce the audio signal 16. The microphone 19 may record the audio signal 16 which may be produced by the first user 53. The first user 53 may control and/or may command the microprocessor 57 via the user interface 55. The microprocessor 57 may be in communication with the memory 59. The memory 59 may store the information 15, the visual signal 23 and/or the audio signal 16. The first user 53 may communicate with the second user 69 via the first server 65, the second server 61 and/or the network 63. The second user 69 may access the terminal 67 which may be, for example, the publication 3. The terminal 67 may be in communication with the database 71.

The publication 3 may display the information 15 to the first user 53. The first user 53 may activate and/or may select the visual signal 23. The publication 3 may display the visual signal 23 via the display panel 21. The publication 3 may produce the audio signal 16 via the speakers 17a, 17b. The audio signal 16 may be, for example, a voice of the visual signal 23. The first user 53 may edit the information 15. The first user 53 may transmit the information 15 to the second user 69 via the first server 65, the second server 61 and/or the network 63.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

I claim:

1. An apparatus for displaying information, the apparatus comprising:
a first page that displays the information;
a display panel in communication with the first page wherein the display panel displays an image wherein the image is dynamic wherein the image changes with time and further wherein the image is described or representative of the information; and
a memory in communication with the first page wherein the memory stores the image; and
an input means in communication with the memory wherein the input means accesses the image from the memory.

2. The apparatus of claim 1 further comprising:
a speaker in communication with the memory wherein the speaker produces a sound wherein the sound is associated with the information.

3. The apparatus of claim 1 wherein the memory is holographic memory.

4. The apparatus of claim 1 further comprising:
a microphone in communication with the memory wherein the microphone records a sound.

5. The apparatus of claim 1 wherein the image is a holographic image.

6. The apparatus of claim 1 further comprising:
a microprocessor in communication with the memory wherein the microprocessor accesses the image from the memory.

7. A system for displaying a visual signal and producing an audio signal, the system comprising:
a publication having a first page which displays information;
a display panel in communication with the publication wherein the display panel displays the visual signal wherein the visual signal is animated wherein the visual signal corresponds to the information; and
a memory in communication with the publication wherein the memory stores a signal corresponding to the image.

8. The system of claim 7 further comprising:
an input means in communication with the memory wherein the inputs means activates the visual signal.

9. The system of claim 7 further comprising:
a speaker in communication with the memory wherein the speaker produces the audio signal wherein the audio signal relates to the information.

10. The system of claim 7 wherein the image is holographic.

11. The system of claim 7 further comprising:
a microphone in communication with the memory wherein the microphone converts the audio signal into data.

12. The system of claim 7 further comprising:
a microprocessor in communication with the memory wherein the microprocessor access the image from the memory.

13. A method for producing an audio signal or displaying a visual signal with a publication, the method comprising the steps of:
displaying information on the publication;
providing a display panel in communication with the publication wherein the display panel displays the visual signal wherein the visual signal is associated with the information;
providing an input means in communication with the publication wherein the input means inputs the information; and
accessing a database remote to the publication wherein the database stores the information or the visual signal.

14. The method of claim 13 further comprising the step of:
providing a speaker in communication with the publication wherein the speaker produces the audio signal wherein the audio signal is associated with the information.

15. The method of claim 13 further comprising the step of:
providing a microphone in communication with the publication wherein the microphone records the audio signal.

16. The method of claim 13 wherein the image is a holographic image.

17. The method of claim 13 further comprising:
providing a microprocessor in communication with the publication wherein the microprocessor accesses the memory to display the image.

18. The method of claim 13 further comprising:
providing a memory in communication with the publication wherein the memory stores the visual signal.

19. The method of claim 14 further comprising the step of:
transmitting the information from the database to the memory.

20. The method of claim 14 further comprising the step of:
transmitting the visual signal from the database to the memory.
